(19) United States
(12) Patent Application Publication
(10) Pub. No.: US 2024/0132064 A1
(43) Pub. Date: Apr. 25, 2024

(54) METHOD AND SYSTEM FOR A LONGITUDINAL CONTROL OF A MOTOR VEHICLE

(71) Applicant: VOLKSWAGEN AKTIENGESELLSCHAFT, Wolfsburg (DE)

(72) Inventors: Bastian SCHMIDT, Wolfsburg (DE); Daniel GOHLKE, Wasbüttel (DE)

(21) Appl. No.: 18/264,162

(22) PCT Filed: Jan. 24, 2022
(86) PCT No.: PCT/EP2022/051521

§ 371 Date: Aug. 2, 2023

(30) Foreign Application Priority Data
Feb. 3, 2021 (DE) 10 2021 200 998.0

(51) Int. Cl. B60W 30/095; B60W 10/04; B60W 10/18

(52) U.S. Cl. CPC B60W 30/0956; B60W 10/04; B60W 10/18; B60W 2554/4042; B60W 2554/4044; B60W 2710/18; B60W 2720/10

(57) ABSTRACT

the at least partially automatic longitudinal control of a transportation vehicle wherein sensor data are generated by a surroundings sensor system wherein the sensor data represent an environment. A computing unit is used, based on the sensor data, to determine a speed vector of a road user in the environment and to predict a potential collision of the road user with the transportation vehicle. Based on the speed vector, it is identified that the road user is moving substantially transverse to a direction of movement of the transportation vehicle and a target speed for the transportation vehicle is computed to avoid the predicted collision. The speed of the transportation vehicle is reduced automatically to the target speed.

### PRIORITY CLAIM

This patent application is a U.S. National Phase of International Patent Application No. PCT/EP2022/051521, filed 24 Jan. 2022, which claims priority to German Patent Application No. 10 2021 200 998.0, filed 3 Feb. 2021, the disclosures of which are incorporated herein by reference in their entireties.

### SUMMARY

Illustrative embodiments relate to a method for the at least partially automatic longitudinal control of a transportation vehicle, wherein sensor data are generated by way of a surroundings sensor system of the transportation vehicle, which sensor data represent an environment of the transportation vehicle, and a computing unit of the transportation vehicle is used, based on the sensor data, to determine a speed vector of a road user in the environment and to predict a potential collision of the road user with the transportation vehicle. Illustrative embodiment also relate to a corresponding vehicle control system and to a transportation vehicle having such a vehicle control system.

### BRIEF DESCRIPTION OF THE DRAWINGS

Disclosed embodiments are described in more detail below with reference to the drawings, in which:

FIG. 1 shows a schematic illustration of a transportation vehicle having an exemplary embodiment of a vehicle control system.

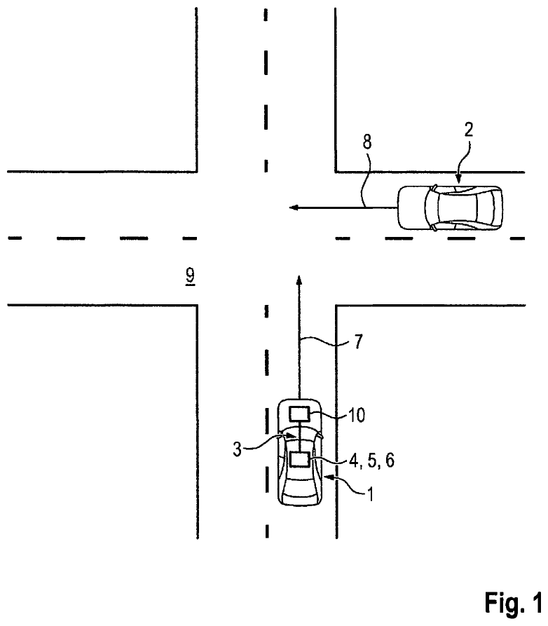

### DETAILED DESCRIPTION

Automatic emergency braking systems for transportation vehicles are known. These follow the intervention strategy of intervening as late as possible not to initiate unnecessary interventions, as long as the driver himself could possibly de-escalate the situation through a dynamic maneuver. Accordingly, in the event of such emergency braking, the transportation vehicle is braked with very strong deceleration.

However, such last-minute and severe braking, in some cases until the transportation vehicle comes to a standstill, is often unpleasant for passengers, since it is accompanied by correspondingly high forces that act on the passengers, and the transportation vehicle has to accelerate again following the emergency braking to achieve the desired travel speed.

Document DE 10 20 11 109 697 A1 specifies a method for operating a transportation vehicle that involves ascertaining whether a turning maneuver is initiated while driving and, in the process, there is a risk of collision with an oncoming road user. If this is the case, an automatic braking intervention is triggered, but is aborted as soon as, for example, a driving speed of the transportation vehicle has been reduced by a predefined speed difference.

Against this background, disclosed embodiments provide an improved concept for the at least partially automatic longitudinal control of a transportation vehicle, by way of which a severity of an intervention in the longitudinal control is reduced, in particular, when the transportation vehicle is traveling straight ahead, for example, at an intersection.

This is achieved here by a method and system for a longitudinal control of a transportation vehicle.

The improved concept is based on the idea of first identifying that another road user is moving substantially transverse to the transportation vehicle and then computing a target speed for the transportation vehicle to avoid a collision with the road user.

According to the improved concept, what is specified is a method for the at least partially automatic longitudinal control of a transportation vehicle, in particular, when the transportation vehicle is traveling straight ahead, for example, when or before driving straight across an intersection A surroundings sensor system of the transportation vehicle is used to generate sensor data that represent an environment of the transportation vehicle. A computing unit of the transportation vehicle is used, based on the sensor data, to determine a speed vector of a road user in the environment and the computing unit is used, based on the sensor data, to predict a potential collision of the road user with the transportation vehicle. The computing unit is used, based on the speed vector, to identify that the road user is moving substantially transverse to a direction of movement of the transportation vehicle and to compute a target speed for the transportation vehicle to avoid a predicted collision. A speed of the transportation vehicle is reduced automatically to the target speed.

The longitudinal control of the transportation vehicle may generally be understood to mean an acceleration or deceleration of the transportation vehicle, in particular, through corresponding actuation of a drive motor or a braking system of the transportation vehicle. The method according to the improved concept is aimed at longitudinal control. However, this does not necessarily rule out the possibility of transverse control of the transportation vehicle being performed, for example, an evasive maneuver or the like.

The transportation vehicle may, for example, have a vehicle control system for the at least partially automatic longitudinal control of the transportation vehicle. The vehicle control system may in this case include the computing unit and/or the surroundings sensor system and/or possibly further controllers or actuators of the transportation vehicle.

The vehicle control system may in this case constitute an electronic system that is configured to drive and to control the transportation vehicle fully automatically or fully autonomously, in particular, without a driver needing to intervene in the control. The transportation vehicle or the vehicle control system in this case performs all necessary functions, such as any necessary steering, braking and/or acceleration maneuvers, monitoring and detecting road traffic and the associated necessary reactions, autonomously and fully automatically. The vehicle control system may then be used to implement a fully automatic or fully autonomous driving mode of the transportation vehicle in accordance with Level 5 of the SAE J3016 classification. However, the vehicle control system may also be designed as a driver assistance system (“advanced driver assistance system”, ADAS) that assists the driver during partially automated or partially autonomous driving of the transportation vehicle. The vehicle control system may be designed as a safety system that is able to be activated, for example, independently of previous activation by the driver. The vehicle control system may be used to implement a partially automated or partially autonomous driving mode of the transportation vehicle in accordance with one of Levels 1 to 4 of the SAE J3016 classification. By way of example, the functionality of the vehicle control system may be limited in this case to the longitudinal control of the transportation vehicle or to the performance of a method according to the improved concept. However, this is not necessarily the case. Here and below, “SAE J3016” refers to the corresponding standard in the version dated June 2018.

Here and below, a surroundings sensor system may be understood to mean a sensor system that is capable of generating sensor data or sensor signals that depict, represent or reproduce the environment of the transportation vehicle or of the surroundings sensor system. In particular, the ability to capture electromagnetic or other signals from the environment is not sufficient to consider a sensor system to be a surroundings sensor system. By way of example, cameras, radar systems, lidar systems or ultrasonic sensor systems may be understood to be surroundings sensor systems. In a method according to the improved concept, the surroundings sensor system may, for example, include one or more cameras, one or more radar systems and/or one or more lidar systems.

The speed vector of the road user corresponds to a direction of movement of the road user. Accordingly, the direction of movement of the transportation vehicle may also be understood and represented as a speed vector of the transportation vehicle. The speed vectors of the road user or of the transportation vehicle may in this case be considered in a common fixed road coordinate system in which a road on which the transportation vehicle and the road user are moving rests. In this sense, the movement of the road user should be understood to be substantially transverse to the direction of movement of the transportation vehicle. However, the actual computations may of course be performed in any coordinate system.

The fact that the road user is moving substantially transverse to the direction of movement of the transportation vehicle may be understood to mean that a transverse movement perpendicular to the direction of movement of the transportation vehicle is more pronounced than a movement component parallel to the direction of movement of the transportation vehicle, for example, considered in the road coordinate system.

In other words, the computing unit may, for example, identify that a component of the speed vector of the road user parallel to the direction of movement is smaller than a component of the speed vector perpendicular to the direction of movement to identify that the road user is moving substantially transverse to a direction of movement of the transportation vehicle.

The computing unit may in this case compare corresponding absolute values of the components of the speed vector with one another. In this case too, for example, a comparison in the road coordinate system may again be assumed.

Based on the speed vector of the road user, the computing unit may also, for example, identify that the road user is moving toward the transportation vehicle and is not moving away from the transportation vehicle. Otherwise, there would be no corresponding collision to predict either. The computing unit may, for example, determine, based on the sensor data and in addition to the speed vector of the road user, a position of the road user, in particular, relative to the transportation vehicle. The computing unit may furthermore optionally use digital map information from the transportation vehicle or information from a receiver for a global navigation satellite system GNSS. Based on the speed vectors of the road user and of the transportation vehicle along with the relative position of the road user in relation to the transportation vehicle, the computing unit is able, in particular, assuming that the transportation vehicle is traveling straight ahead and possibly that the road user is doing so as well, to forecast a corresponding location and/or a time of the potential collision to predict the collision. The computing unit may furthermore optionally, based on the sensor data or based on a V2X communication, ascertain information about intentions of the road user, for example, a desire to turn or the like, and also take this information into account when predicting the potential collision.

The target speed is computed by way of the computing unit such that, provided that the transportation vehicle is braked accordingly to the target speed, the collision is able to be prevented with a sufficiently high probability. The target speed is in this case less than a current speed of the transportation vehicle, and generally other than zero. The direction of the speed vector of the transportation vehicle is not necessarily changed as part of the improved concept.

To reduce the speed of the transportation vehicle automatically to the target speed, at least one control unit of the transportation vehicle may, for example, actuate a braking system and/or a drive motor of the transportation vehicle. The at least one control unit may in this case, for example, be part of the computing unit or vice versa, or the computing unit may issue corresponding instructions to the at least one control unit.

Computing the target speed to avoid the predicted collision also avoids having to brake the transportation vehicle unnecessarily severely, for example, until it comes to a standstill, in particular, as part of an emergency braking procedure. To this end, the environment of the transportation vehicle may accordingly be monitored predictively by way of the surroundings sensor system at early points in time and, as objective of the intervention strategy, the lowest possible speed reduction of the transportation vehicle may be ascribed greater importance.

In this case, it is particularly beneficial for the road user to be moving substantially transverse to the direction of movement of the transportation vehicle since, in this case, it is probable that any even slight adjustment of the speed of the transportation vehicle achieves a situation whereby the trajectories of the road user and of the transportation vehicle do not come close.

The road user is another transportation vehicle. In such exemplary embodiments, due to the typically higher speed of a transportation vehicle, compared, for example, to a pedestrian, a slight adjustment of the speed of the transportation vehicle is more effective.

According to at least one disclosed embodiment of the method according to the improved concept, an absolute value of the target speed is greater than zero if this makes it possible to avoid the predicted collision.

In other words, emergency braking or braking of the transportation vehicle to a standstill is performed only if the collision cannot be avoided by otherwise reducing the target speed, that is to say if a predefined minimum distance between the road user and the transportation vehicle would otherwise be fallen below. This ascribes greater importance to the objective of keeping the severity of the intervention as low as possible, so as to increase user comfort for passengers of the transportation vehicle.

According to at least one disclosed embodiment, the target speed is computed by way of the computing unit such that a difference between a current speed of the transportation vehicle and the target speed is minimized under the condition that the predicted collision is able to be avoided.

This means that the deceleration of the transportation vehicle may be set to be as low as possible, and the intervention may thus be made as comfortable as possible. The smallest possible difference between current speed and target speed may be achieved by setting the starting time of the intervention, that is to say of the speed reduction, as early as possible after the potential collision has been predicted.

According to at least one disclosed embodiment, the target speed is computed by way of the computing unit such that a predicted minimum distance between the road user and the transportation vehicle is greater than or equal to the predefined minimum distance.

In particular, the computing unit may, based on the sensor data, predict respective trajectories of the road user and of the transportation vehicle and determine the minimum distance based thereon. The predefined minimum distance may in this case correspond to a distance at which it is sufficiently likely that a collision or near miss may be assumed to be ruled out. To this end, the computing unit may, for example, compute the minimum distance as a function of a value for the target speed and set the target speed accordingly. The risk of a collision or near miss may be reduced in such exemplary embodiments.

In particular, the absolute value of the target speed is equal to zero only if it is not possible to ensure that the predicted minimum distance is greater than or equal to the minimum distance without predefining the target speed of zero.

According to at least one disclosed embodiment, the target speed is computed by way of the computing unit such that a difference between the predicted minimum distance and the predefined minimum distance is minimized.

In other words, the target speed is chosen to be as high as possible so that the minimum distance may still be maintained. User comfort is thereby maximized.

According to at least one disclosed embodiment, a braking system of the transportation vehicle is actuated automatically by way of a brake control unit of the transportation vehicle to reduce the speed of the transportation vehicle automatically to the target speed.

In particular, the braking system, actuated by the brake control unit, actively brakes the transportation vehicle to reduce speed. The brake control unit may in this case be part of the computing unit or vice versa. However, the brake control unit and the computing unit may also be designed separately from one another. In the latter case, the computing unit and the brake control unit are in a communication connection, such that the computing unit of the brake control unit is able to transmit the target speed or the braking deceleration to be set.

According to at least one disclosed embodiment, a drive motor of the transportation vehicle is actuated automatically by way of an engine control unit of the transportation vehicle to reduce the speed of the transportation vehicle automatically to the target speed.

The engine control unit actuates the drive motor such that the engine torque of the drive motor is reduced, in order to reduce speed. The engine control unit may in this case be part of the computing unit or vice versa. However, the engine control unit and the computing unit may also be designed separately from one another. In the latter case, the computing unit and the engine control unit are in a communication connection, such that the computing unit of the engine control unit is able to transmit the target speed.

The active braking of the transportation vehicle by way of the braking system may also be combined with a reduced engine torque by actuating the drive motor.

According to the improved concept, what is also specified is a vehicle control system for the at least partially automatic longitudinal control of the transportation vehicle. The vehicle control system has a surroundings sensor system that is configured to generate sensor data that represent an environment of the transportation vehicle. The vehicle control system has a computing unit that is configured, based on the sensor data, to determine a speed vector of a road user in the environment and, based on the sensor data, to predict a potential collision of the road user with the transportation vehicle. The computing unit is configured, based on the speed vector, to identify that the road user is moving substantially transverse to a direction of movement of the transportation vehicle. The computing unit is configured to compute a target speed for the transportation vehicle to avoid the predicted collision. The vehicle control system furthermore has at least one control unit that is configured to actuate a braking system of the transportation vehicle and/or a drive motor of the transportation vehicle to automatically reduce a speed of the transportation vehicle to the target speed.

The at least one control unit may accordingly include a brake control unit and/or an engine control unit and may be part of the computing unit, or the computing unit may be part of the at least one control unit, or the at least one control unit may be designed separately from the computing unit.

According to at least one disclosed embodiment of the vehicle control system, the surroundings sensor system includes a camera and/or a radar system and/or a lidar system.

Further exemplary embodiments of the vehicle control system according to the improved concept follow directly from the various exemplary embodiments of the method according to the improved concept and vice versa. In particular, a vehicle control system is configured to perform a method according to the improved concept, or it performs such a method.

According to the improved concept, what is also specified is a transportation vehicle that includes a vehicle control system according to the improved concept.

In the exemplary embodiments, the described components each constitute individual features of the disclosure that should be considered independently of one another, that each also develop the disclosure independently of one another and that should thus be considered to be part of the disclosure individually or in a combination other than that shown. Furthermore, the described exemplary embodiments may also be supplemented by more of the features of the disclosure that have already been described.

The FIGURE shows a transportation vehicle 1 that is moving straight ahead on a road toward an intersection. The transportation vehicle 1 has an exemplary embodiment of a vehicle control system 3 according to the improved concept. Additionally shown is a further road user 2, for example, a further transportation vehicle, moving on a further road toward the intersection 9.

The vehicle control system 3 has a surroundings sensor system 10, which may, for example, include a camera, a radar system and/or a lidar system. In addition, the vehicle control system 3 has a computing unit 4 and a brake control unit 5 and/or an engine control unit 6.

An instantaneous speed vector 7 of the transportation vehicle 1 points from the transportation vehicle 1 in the direction of the intersection 9, and an instantaneous speed vector 8 of the road user 2 likewise points from the road user 2 in the direction of the intersection 9. The speed vectors 7, 8 are thus, for example, approximately perpendicular to one another. In other words, the road user 2 represents cross traffic for the transportation vehicle 1. Based on measured data from the surroundings sensor system 10, the latter is able to generate sensor data and transmit them to the computing unit 4. The computing unit 4 may, based on the sensor data, determine the speed vector 8 of the road user 2, on the one hand, and, on the other hand, for example, based on a relative position of the transportation vehicle 1 with respect to the road user 2 and the speed vectors 7, 8, predict a potential collision of the road user 2 with the transportation vehicle 1 in the region of the intersection 9.

The computing unit 4 may then identify, for example, based on the speed vector 8, that the road user 2 is moving substantially transverse to the direction of movement of the transportation vehicle. The computing unit 4 may compute a target speed for the transportation vehicle 1, such that the predicted collision is able to be avoided if the speed of the transportation vehicle 1 is reduced to the target speed.

The computing unit 4 may then instruct the brake control unit 5 to actuate a braking system (not shown) of the transportation vehicle 1 to reduce the speed of the transportation vehicle 1 to the target speed and/or instruct the engine control unit 6 to actuate a drive motor (not shown) of the transportation vehicle 1 to reduce an engine torque of the drive motor, to reduce the speed of the transportation vehicle 1.

The target speed is in this case generally greater than zero. The early reduction of the speed of the transportation vehicle 1 makes it possible, for example, to achieve a situation whereby the road user 2 has already left the region of the intersection 9 again when the transportation vehicle 1 is in the region of the intersection 9. The potential collision may thus be prevented without the need for very severe emergency braking of the transportation vehicle 1, for example, until the transportation vehicle 1 comes to a standstill.

According to the improved concept, as described with reference to the FIGURE, an intervention strategy is made possible in which the transportation vehicle is braked only to the extent that it arrives at the potential collision location, for example, in the region of the intersection, a sufficient time later than the further road user, to prevent a collision. The intervention may in this case be designed such that it is activated sufficiently early, so that only a slight speed reduction is sufficient to eliminate the risk of collision.

The intervention strategy in this case, for example, achieves an optimum from an automatic intervention that is as early as possible, on the one hand, to achieve a situation whereby target speed and starting speed differ as little as possible. On the other hand, the intervention may take place so late that an unnecessary intervention, in particular, from the driver's point of view, is avoided, for example, if the situation is de-escalated through the behavior of the road user.

The improved concept thus makes is possible to reduce the risk of collision, wherein the intensity of the speed reduction or the extent of the speed reduction is lower than in known methods. The intervention may in this case, for example, be carried out through active braking by the wheel brakes or else by reducing the engine torque, or through a combination.

### LIST OF REFERENCE SIGNS

1 transportation vehicle
2 road user
3 vehicle control system
4 computing unit
5 brake control unit
6 engine control unit
7, 8 speed vectors
9 intersection
10 surroundings sensor system

1. A method for the at least partially automatic longitudinal control of a transportation vehicle, the method comprising:
generating sensor data using a surroundings sensor system of the transportation vehicle, which sensor data represent an environment of the transportation vehicle; and
determining, by a computing unit of the transportation vehicle a speed vector of a road user in the environment based on the sensor data;
predicting, by the computer unit, a potential collision of the road user with the transportation vehicle;
identifying, by the computing unit, based on the speed vector (8), whether the road user is moving substantially transverse to a direction of movement of the transportation vehicle;
in response to prediction of potential collision, computing, by the computing unit a target speed for the transportation vehicle to avoid the predicted collision; and
automatically reducing a speed of the transportation vehicle to the target speed based on the computation of the target speed to avoid the predicted collision.

2. The method of claim 1, wherein to identify whether the road user is moving substantially transverse to a direction of movement of the transportation vehicle, the computing unit identifies whether a component of the speed vector parallel to the direction of movement is smaller than a component of the speed vector perpendicular to the direction of movement.

3. The method of claim 1, wherein avoiding the predicted collision is performed by reducing the target speed, wherein:
an absolute value of the target speed is greater than zero; and/or
a difference between a current speed of the transportation vehicle and the target speed is minimized while the predicted collision is avoided.

4. The method of claim 1, wherein of the target speed is computed by the computing unit such that a predicted minimum distance between the road user and the transportation vehicle is greater than or equal to a predefined minimum distance.

5. The method of claim 4, wherein the target speed is computed by the computing unit such that a difference between the predicted minimum distance and the predefined minimum distance is minimized.

6. The method of claim 1, wherein a braking system of the transportation vehicle is actuated by a brake control unit of the transportation vehicle to reduce the speed of the transportation vehicle automatically to the target speed.

7. The method of claim 1, wherein a drive motor of the transportation vehicle is actuated by an engine control unit of the transportation vehicle to reduce the speed of the transportation vehicle automatically to the target speed.

8. A vehicle control system for at least partially automatic longitudinal control of a transportation vehicle, the vehicle control system comprising:
a surroundings sensor system configured to generate sensor data that represent an environment of the transportation vehicle; and
a computing unit configured, based on the sensor data, to determine a speed vector of a road user in the environment and to predict a potential collision of the road user with the transportation vehicle,
wherein the computing unit is further configured, based on the speed vector, to identify whether the road user is moving substantially transverse to a direction of movement of the transportation vehicle,
wherein the computing unit is further configured to compute a target speed for the transportation vehicle to avoid the predicted collision, and
wherein the vehicle control system has at least one control unit that is configured to actuate a braking system of the transportation vehicle and/or a drive motor of the transportation vehicle to automatically reduce a speed of the transportation vehicle to the target speed.

9. The vehicle control system of claim 8, wherein the surroundings sensor system includes a camera and/or a radar system and/or a lidar system.

10. A transportation vehicle having a vehicle control system of claim 8.

11. The vehicle control system of claim 9, wherein to identify whether the road user is moving substantially transverse to a direction of movement of the transportation vehicle, the computing unit identifies whether a component of the speed vector parallel to the direction of movement is smaller than a component of the speed vector perpendicular to the direction of movement.

12. The vehicle control system of claim 9, wherein avoiding the predicted collision is performed by reducing the target speed, wherein:
an absolute value of the target speed is greater than zero; and/or
a difference between a current speed of the transportation vehicle and the target speed is minimized while the predicted collision is avoided.

13. The vehicle control system of claim 9, wherein the target speed is computed by the computing unit such that a predicted minimum distance between the road user and the transportation vehicle is greater than or equal to a predefined minimum distance.

14. The vehicle control system of claim 13, wherein the target speed is computed by the computing unit such that a difference between the predicted minimum distance and the predefined minimum distance is minimized.

15. The vehicle control system of claim 9, wherein a braking system of the transportation vehicle is actuated by a brake control unit of the transportation vehicle to reduce the speed of the transportation vehicle automatically to the target speed.

16. The vehicle control system of claim 9, wherein a drive motor of the transportation vehicle is actuated by an engine control unit of the transportation vehicle to reduce the speed of the transportation vehicle automatically to the target speed.
